(19) United States
(12) Patent Application Publication
(10) Pub. No.: US 2013/0162682 A1
(43) Pub. Date: Jun. 27, 2013

(54) VERTICAL SCAN PANEL WITH CONVERSION MODE CAPABILITY

(71) Applicant: ATI TECHNOLOGIES ULC, Markham (CA)

(72) Inventors: Roger J. Quero, Mississauga (CA); David I.J. Glen, Toronto (CA); Syed A. Hussain, Scarborough (CA)

(73) Assignee: ATI TECHNOLOGIES ULC, Markham (CA)

(21) Appl. No.: 13/724,142

(22) Filed: Dec. 21, 2012

Related U.S. Application Data
(60) Provisional application No. 61/578,384, filed on Dec. 21, 2011.

(51) Int. Cl. G09G 5/34

(52) U.S. Cl. CPC G09G 5/34
USPC 345/649

(57) ABSTRACT

A method and apparatus for providing an image on a vertical scan panel determines whether a mode of operation for a vertical scan panel is either a scan conversion pass-through mode or a horizontal scan conversion mode. If the determined mode is the horizontal scan conversion mode, the method and apparatus converts display data in the vertical scan panel from a horizontal scan format to a vertical scan format and displays the converted display data on the vertical scan panel. However, if the determined mode is the scan conversion pass-through mode, the method and apparatus includes displaying display data on the vertical scan panel in a vertical scan format without applying a scan conversion operation on the display data.

### RELATED APPLICATIONS

This application claims priority to Provisional Application Ser. No. 61/578,384, filed on Dec. 21, 2011, having inventors Roger Quero et al., titled “VERTICAL SCAN PANEL WITH CONVERSION MODE CAPABILITY”, and is incorporated herein by reference.

### BACKGROUND OF THE DISCLOSURE

The disclosure relates generally to vertical scan panels that provide pixel display data using scan drivers along a short axis leg of a panel.

Horizontal scan panels, such as LCD panels and other panels are typically designed to scan in and send RGB data pixels in a horizontal manner from left to right, starting from the top row of pixels. Due to the manner in which data is scanned, the drivers of the panel are aligned with the columns of the panel. The wider the panel, the more column drivers that are needed, thereby increasing the cost of the solution. For example, using RGB data and a 1024 wide screen, more than 3000 column drivers and control circuitry may be used. The current trend in the display industry is to use wide aspect ratio panels. Panel vendors have been looking for ways to change the physical scan orientation vertically to reduce costs. These panels are referred to as vertical scan panels. The result is fewer drivers since instead of column drivers, row drivers are used along the short axis of the panel as opposed to column drivers being along the long axis of the panel. Unfortunately, graphics processor units and operating systems have been designed to scan out data horizontally. Vertical scan panels may be used, for example, in smart phones.

Horizontal scan panels may be used to translate the orientation of an image such as from a portrait mode to a landscape mode, however the drivers of the panel are still typically located on the long axis. Horizontal scan panels are also known to include panel self refresh (PSR) which refers to a system implementation where a timing controller in the horizontal scan panel has an embedded frame buffer. When the screen of the panel is in a static mode, such as when content on the screen does not change, the panel is refreshed by the timing controller using content stored in the panel's embedded frame buffer. This allows an image source, such as a graphics processor unit to enter a very low power state. The DisplayPort link or other panel interface may also be decoded to reduce overall system power consumption. Horizontal self refresh displays may operate on a full frame or partial frame update basis.

By way of example, as shown in FIG. 1, a horizontal scan panel 100 receives display data such as frames of pixels indicated as 102 from an image source device 104. The image source device 104 may be, for example, any type of computing system, game console, mother board or any other image providing system. As known in the art, auxiliary channel 106 which may be, for example, a DDC, DisplayPort AUX channel or any suitable link and is used to communicate control information between the horizontal display to the image source. Each of the horizontal scan panel 100 and the image source 104 have a respective display interface 108 and 110 which may be, for example, embedded DisplayPort (eDP) interface, DisplayPort interface or any other suitable display interface as desired.

As shown, the horizontal image display panel 100 includes a screen 112 and a series of column drivers 114. In this example, a timing controller 116 is shown that includes panel self refresh operation as known in the art. A frame buffer 118 is also employed which is not used in normal operation but is turned on during the panel self refresh to store the static frame data that is to be displayed on the screen during a static screen mode. The functional operations may be suitably linked using known communication techniques.

The image source device 104 in this example includes an image provider 120 such as a graphics processing core, video decoder or other suitable structure that provides display data. Device 104 also includes a display controller 122 as known in the art that outputs the display data that has been generated by the image provider 120 from frame buffer 124. A power management controller 126 may suitably reduce power consumption through various known methods including reducing clocking frequencies and voltage levels of circuits or subsystems. In this example, a static frame detector 128 is used to detect a static frame condition. When a static frame condition occurs, the frame information does not change and hence the power management controller 126 can reduce the power consumed by the image provider and device 104. The static frame detector as known in the art may be a suitably executing driver that is executing on a processor, an executing operating system, it may be implemented in any suitable hardware or any other suitable manner. A problem with the system shown in FIG. 1 is that the horizontal scan panel utilizes a large number of column drivers 114 which results in a high cost of panels.

FIG. 2 illustrates one example of a proposed vertical scan panel 200 that is coupled to an image source provider 104. Unlike the screen 112 in FIG. 1, the screen 202 is a vertical scan screen that has row drivers 204 along the short axis or short leg of the screen, resulting in a lower cost panel. However, as known in the art, the timing controller 206 is not operational to provide a panel self refresh operation but can provide a horizontal to vertical scan format conversion. This is useful since the image source 104 typically outputs a frame formatted for a horizontal scan panel. The vertical scan panel 200 assumes that it receives horizontal scan format data and always translates the horizontal scan format to a vertical scan format so it can be suitably output and displayed as an image of pixels on the vertical scan screen 202. The conversion can take additional time and introduce delay between time and images communicated from the source to the time it was actually displayed on the screen and the panel cannot be used with sources that provide vertical format data.

Accordingly, a need exists for an improved vertical scan panel and system.

### BRIEF DESCRIPTION OF THE DRAWINGS

The embodiments will be more readily understood in view of the following description when accompanied by the below figures and wherein like reference numerals represent like elements, wherein:

FIG. 1 is a block diagram illustrating one example of a prior art horizontal scan panel system;

FIG. 2 is a block diagram illustrating one example of a proposed vertical scan panel system;

FIG. 3 is a block diagram illustrating one example of a vertical scan panel system in accordance with one example set forth in the disclosure;

FIG. 4 is another example of a vertical scan panel system in accordance with another embodiment set forth in the disclosure;

FIG. 5 is a flowchart illustrating one example of a method for providing an image on a vertical scan panel in accordance with one example set forth in the disclosure;

FIG. 6 is a flowchart illustrating one example of a method for providing an image on a vertical scan panel in accordance with one example set forth in the disclosure; and

FIG. 7 is a block diagram illustrating one example of a controller in a vertical scan panel in accordance with one example set forth in the disclosure.

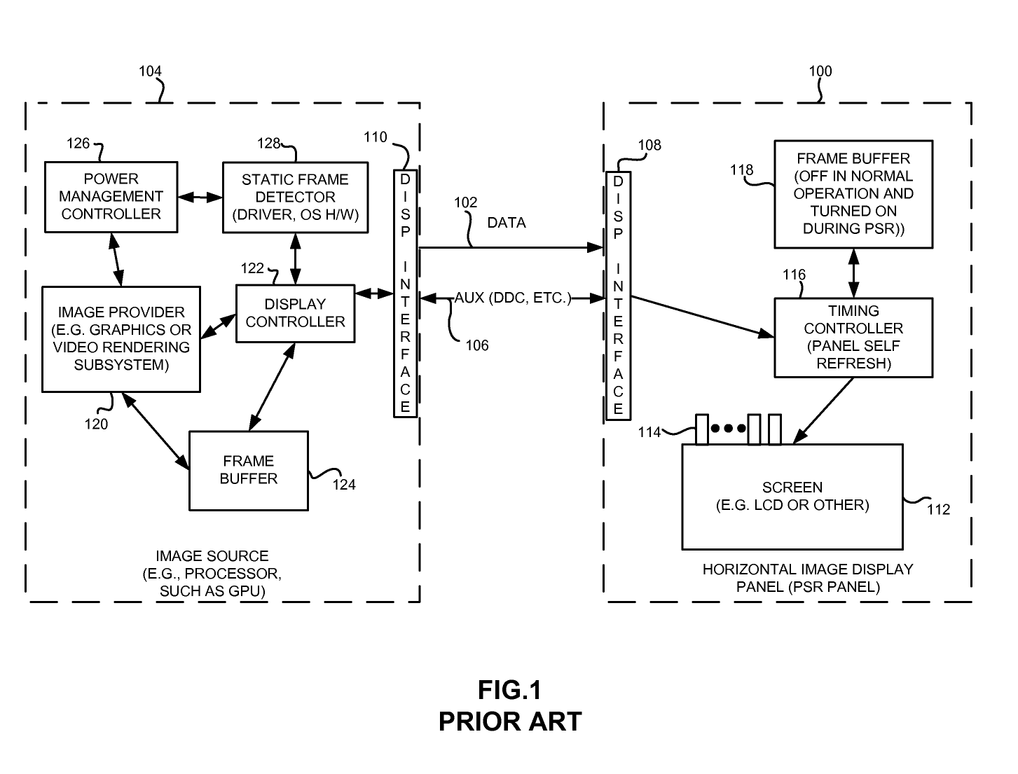

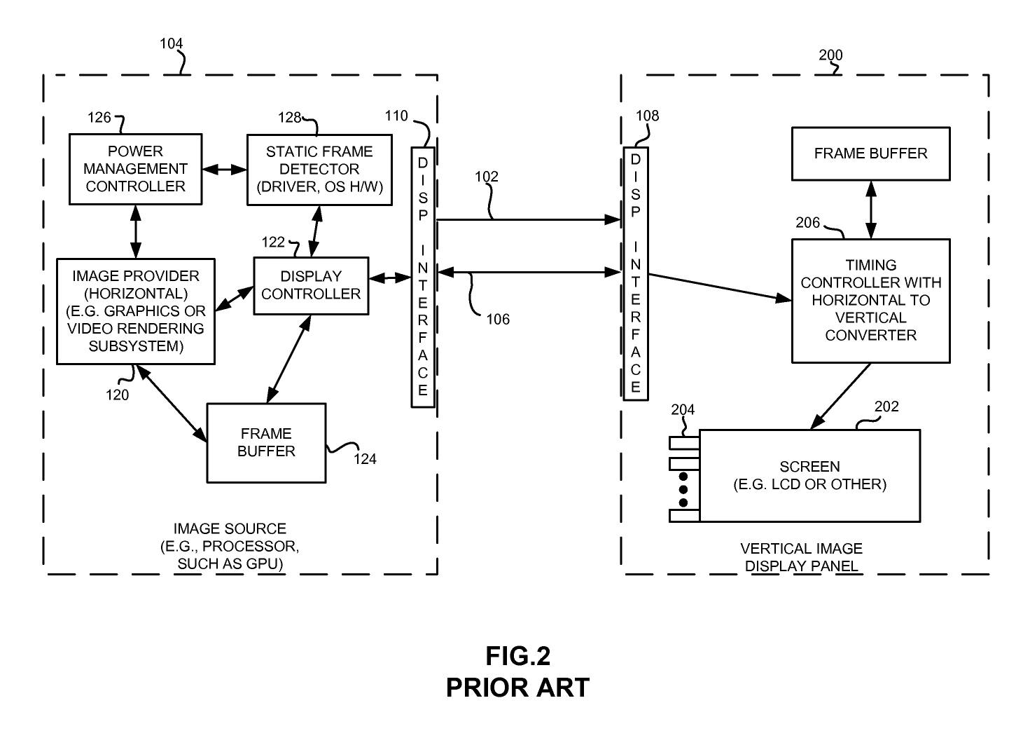

### DETAILED DESCRIPTION OF THE PREFERRED EMBODIMENTS

Briefly, a method and apparatus for providing an image on a vertical scan panel determines whether a mode of operation for a vertical scan panel (VSP) is either a scan conversion pass-through mode or a horizontal scan conversion mode. If the determined mode is the horizontal scan conversion mode, the method and apparatus converts display data in the vertical scan panel from a horizontal scan format to a vertical scan format and displays the converted display data on the vertical scan panel. However, if the determined mode is the scan conversion pass-through mode, the method and apparatus includes displaying display data on the vertical scan panel in a vertical scan format without applying a scan conversion operation on the display data. In another example, the method and apparatus for providing an image on a vertical scan panel includes using a frame buffer in the vertical scan panel during a self refresh mode to store the static frame (or a portion thereof) of information to be stored on the screen of the vertical scan panel and also use the same frame buffer in the vertical scan panel to convert display data from a horizontal scan format to a vertical scan format when the vertical scan panel is out of a self refresh mode. As used herein a frame may be less than an entire frame. In one example, a timing controller in the vertical scan panel controls the pass-through of already vertically scan formatted display data or converts any horizontal scan formatted display data received from an image source to a vertical scan format. In addition if desired, the timing controller also includes panel self refresh mode to use the frame buffer during both a self refresh mode as well as for the horizontal to vertical scan format conversion.

In yet another example, vertical scan panel mode capability data is provided between the vertical scan panel and an image source device, such as vertical scan panel capability data indicating for example whether the vertical scan panel is capable of performing a pass-through and/or a horizontal to vertical scan conversion and as such the image source can determine whether the image source must perform a horizontal to vertical scan conversion.

Among other advantages, in one example, using panel self refresh (PSR) timing controllers that already have embedded frame buffer operation may result in little additional overhead costs in supporting an improved vertical scan panel operation and the scan mode can be controlled by the image source device or by the vertical scan panel (timing controller for example) depending upon the situation. The pass-through mode of operation can yield better performance by reducing image latency. In addition, new EDID/DID fields can allow for plug and play operation for communicating capability information between the vertical scan panel and the image source. Other advantages will be recognized by those of ordinary skill in the art.

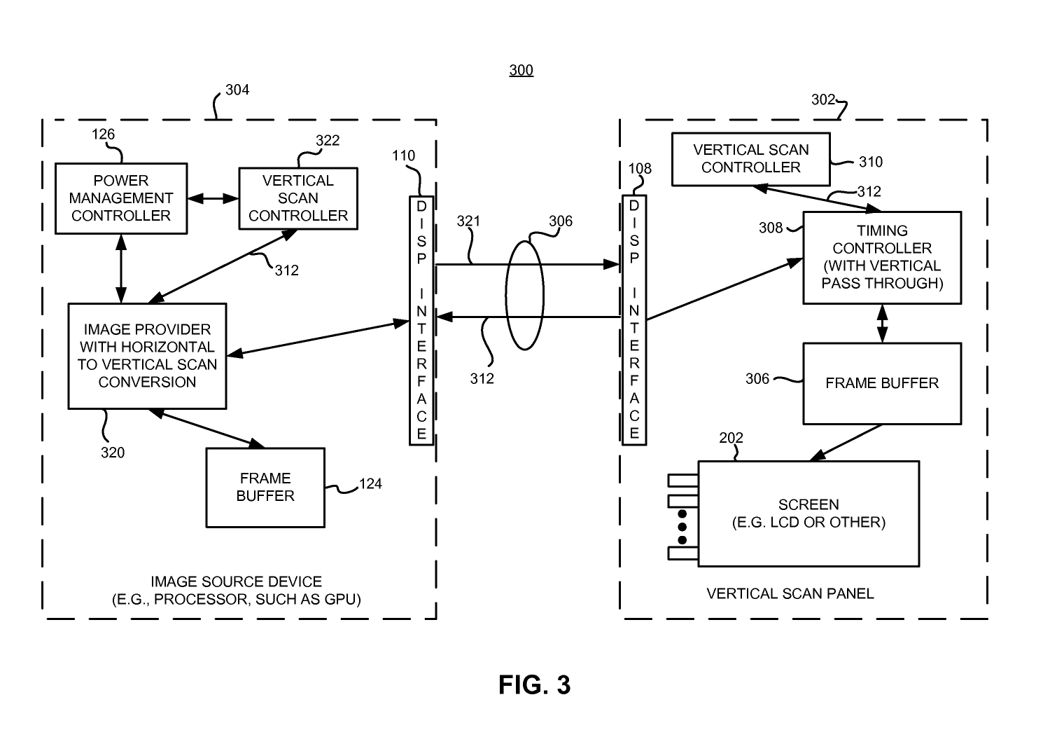

FIG. 3 illustrates one example of a display system 300 that includes a vertical scan panel 302 and an image source device 304 that are in communication through a suitable communication link 306 such as a DisplayPort link or any other suitable link. In this example, the vertical scan panel 302 includes the screen 202, frame buffer 306 and a controller 308 that has a vertical pass-through mode. In this example, the controller 308 is implemented as a timing controller, however any suitable controller may be employed such as a microcontroller, suitably programmed processor, discrete logic including state machines, or any suitable combination of hardware and software.

The vertical scan panel 302 also includes a vertical scan controller 310 that it is communication with the controller 308 that provides VSP mode capability data that indicates whether the vertical scan panel has capability to provide pass-through and/or horizontal scan format conversion to vertical scan format conversion through a suitable communication 312 of the timing controller. The timing controller 308 may then pass the vertical scan panel mode capability data 312 to the image source device 304. For example, the vertical scan controller in this example may determine whether a mode of operation of the vertical scan panel is either a scan conversion pass-through mode or a horizontal scan conversion mode. In this example, there is no horizontal to vertical scan mode capability in the vertical scan panel. Accordingly, such conversion must be done by the image source device. Accordingly, the image source device has a horizontal to vertical scan converter 320 which is also referred to as an image provider with horizontal to vertical scan conversion since the image provider and horizontal to vertical scan conversion module 320 may be a graphics processor for example, that generates the frame display data (pixels) that are provided to the display interface 110 for display on screen 202. In this example, the vertical scan controller 322 which may be, for example, an application executing on a CPU or may be hardware, evaluates the vertical scan panel capability data (panel capability data) from the vertical scan panel to determine whether or not the vertical scan panel has the capability to do its own horizontal to vertical scan format conversion. If not, the vertical scan converter 322 notifies the image provider 320 to provide horizontal to vertical scan conversion.

In addition if desired, the vertical scan controller may be in communication with the power management controller 126 so that its power may be shut down or reduced if it is not necessary given the type of vertical scan panel that is connected to the display interface. The power management controller 126 may also reduce the power consumed by the image provider with horizontal to vertical scan conversion 320 when, for example, the vertical scan panel is in a static mode. The capability data 312 is also referred to as vertical scan panel mode capability data in the instance where it indicates whether or not the vertical scan panel can perform its own horizontal to vertical scan format conversion. The VSP capability data 312 may indicate, for example, the capability to convert horizontal to vertical scan data, the capability to pass-through vertical scan data, and any timing requirements depending upon, for example, the size of the screen 202. Any other suitable capability data may also be provided. In this example, the capability of the sync device or vertical scan panel is provided to the image source device 304 to support vertical scan timing. The VSP mode capability data may be sent in any suitable format including but not limited to part of EDID or display ID format.

The capability data may be suitably stored in memory in the vertical scan controller or any other suitable location and may be determined by the manufacturer of the vertical scan panel. In this example, the vertical scan panel would have capability data that indicates that the vertical scan panel provides pass-through of vertical scan information thus letting the image source device 304 know that it must perform the horizontal to vertical scan conversion operation.

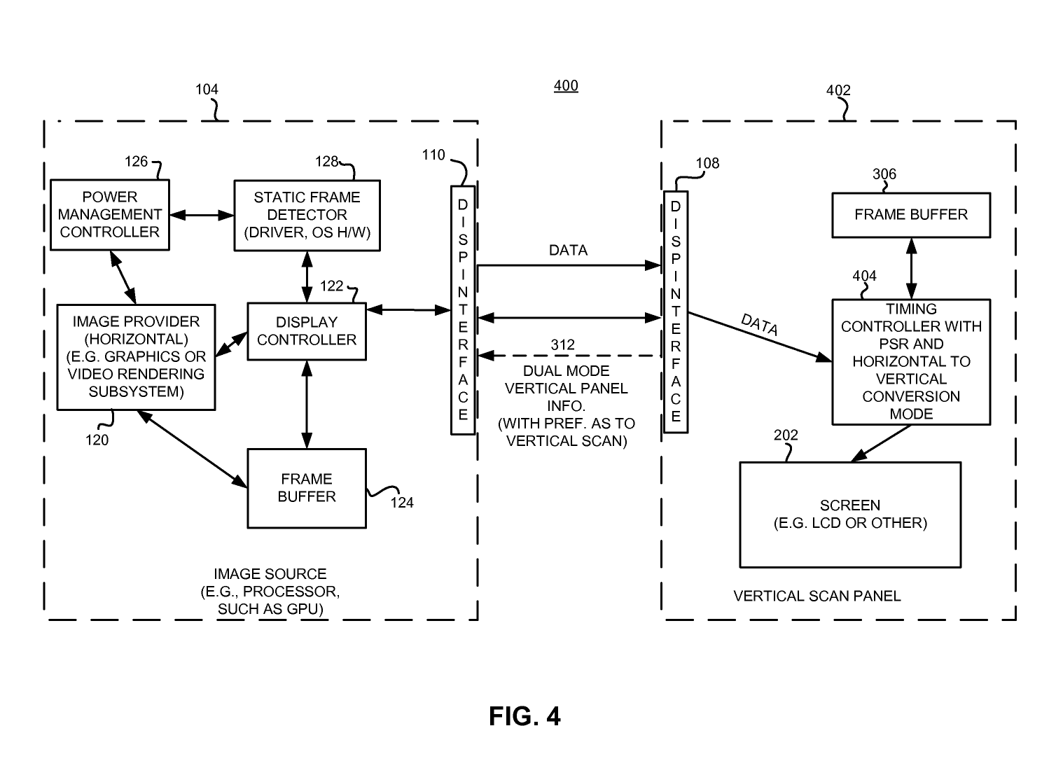

FIG. 4 illustrates another example of a display system 400 wherein the vertical scan panel 402 includes a controller that provides panel self refresh and horizontal to vertical scan format conversion designated as controller 404 (e.g., timing controller with PSR and horizontal to vertical conversion mode). This may be implemented, for example, as a timing controller if desired or in any other suitable structure including, but not limited to, programmable microcontroller, discrete logic, state machines, processor executing code, or any suitable combination as desired. In this example, the image source only provides horizontal scan images but the vertical scan panel performs the conversion of display data from a horizontal scan format to a vertical scan format. Also in this example, the controller utilizes the self refresh buffer 306 during a self refresh mode and also uses the self refresh frame buffer to convert horizontally scanned pixel data to vertically scanned pixel data for output to screen 202. In this example, no pass-through mode is necessary since the image source device 104 does not convert from a horizontal scan format to a vertical scan format for image frames.

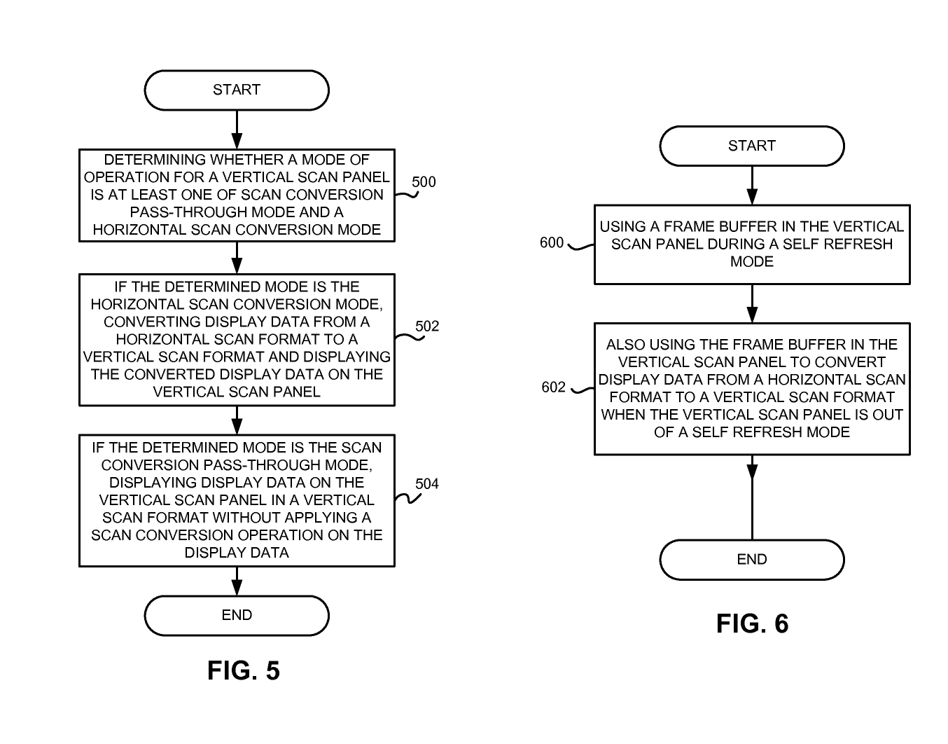

However, in another example, the combination of the controllers 404, 206 and 308 provide an operation that allows a more robust legacy operation so that image source devices that only provide horizontal images can be connected to the vertical scan panel as well as image source devices that have internal horizontal to vertical scan format converting operations. Referring to FIG. 5, in operation, the vertical scan panel includes the controller that determines whether a mode of operation of the vertical scan panel is at least one of a scanned conversion pass-through mode or a scan horizontal conversion mode. This is shown in block 500. As shown in block 502, the method may also include that if it is determined that the mode is horizontal scan conversion mode, the method includes converting display data from the horizontal scan format to the vertical scan format and displaying the converted display data on the vertical scan panel screen. This may be done, for example, through the controller and horizontal to vertical scan controller. The displaying of the display data is done on the screen in the vertical scan format without applying a scan conversion operation on the display data if the determined mode is the scan conversion pass-through mode. This is shown in block 504. Accordingly, in a pass-through mode, the timing controller in one example will simply pass through the display data from the image source device without any conversion. This requires the source device to be capable of scanning out the data in the vertical scan orientation. This mode may be useful to help ensure that latency is minimized. The panel self refresh function may also be used in this mode for static screen content conditions.

In the conversion mode, the source device scans the RGB data (or other component format) out horizontally and the timing controller in the vertical scan panel converts to the vertical scan orientation. This is useful to support legacy devices that only output data in horizontal scan orientation. This mode may also be useful when the device is in a boot menu (i.e., DOS) and only VESA timing are supported. Again the panel self refresh function may also be used in this mode for static screen content conditions. The controller 404 has the ability to be signaled into one of the two operation modes to, for example, the eDP AUX channel communication with the image source device 104 or in any suitable manner.

Referring to FIG. 6, the method includes, as shown in block 600, using a frame buffer in the vertical scan panel during a self refresh mode and as shown in block 602, also using the frame buffer in the vertical scan panel to convert display data from a horizontal scan format to a vertical scan format when the vertical scan panel is out of refresh mode. This may be done, for example, by the controller 404. Reuse of the PSR frame buffer for scan direction conversion operations can reduce cost and complexity. Hence, the controller 404 can determine whether a mode of operation of the vertical scan panel is at least one of a scan conversion pass-through mode or a horizontal scan conversion mode and operate according to the appropriate vertical scan panel mode. The controller 404 may send vertical scan panel mode capability data 312 to the image source device that indicates the vertical scan panel can perform horizontal scan format to vertical scan format conversion if desired.

The image source device may, as shown in FIG. 3, include the horizontal to vertical scan converter and if it is coupled to the vertical scan panel 402, either device may perform the horizontal to vertical conversion and as such, the capability data assists in this mode as well since either device can perform the conversion. It may be desirable to select which of the two devices performs a conversion depending upon the type of data and potential delays involved. The image source device as noted in FIG. 3 may include the horizontal to vertical scan converter to convert display data from a horizontal scan format to a vertical scan format to produce converted vertical scan display data in response to vertical scan panel mode capability data 312 when the capability data indicates, for example, when the controller 308 does not have the capability of such conversion. The display interface 110 sends the converted vertical scan display data to the vertical scan panel. This is shown as vertical display data 321. Also if desired, the frame buffer 306 may be embedded in a same die as the timing controller 308 or 404 if desired.

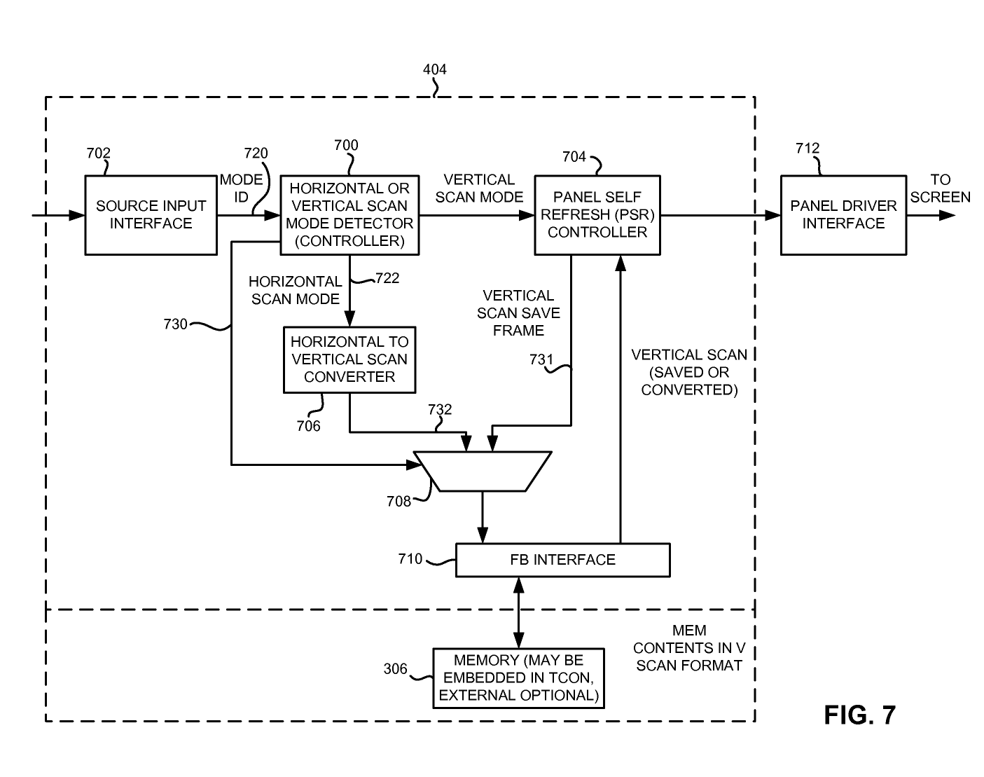

FIG. 7 is a more detailed diagram of controller 404 and in this example, the controller includes a horizontal or vertical scan mode detector 700, a source input interface 702, a panel self refresh controller 704, a horizontal to vertical scan converter 706, a switching circuit 708, a frame buffer interface 710 coupled to the frame buffer 306. The controller 404 may be coupled to or include a panel driver interface 712. The source input interface 702 receives the data and any communication information from the image source device. In this example, the image source device may provide a mode identifier 720 indicating whether the vertical scan panel should operate as a horizontal to vertical scan converter or in a pass-through mode. The mode ID may be generated based on the capability information 312 that was sent previously or may be provided through any suitable communication between the vertical scan panel and the image source device as desired. If the mode ID indicates that the image source device is operating in a horizontal scan mode as indicated by data 722, the horizontal to vertical scan converter converts the incoming display data and provides it to switch 708. The controller 700 provides control information 730 to the switch 708 to select the vertical scan frame from the panel self refresh controller 704 or the converted horizontally scanned format data 732 to the frame buffer 306 via frame buffer interface 710. The converted horizontally scanned pixel data (vertically scanned pixel data) is shown as 732. If the image source already has a vertical scan capability and the data is already in a vertical scan mode the data is passed to the self refresh controller which then passes the vertical scan pixel data 731 to the switch 708 for storage in the frame buffer. The vertical scan pixel data 731 is carried from the source device when the self refresh controller is saving an image to the frame buffer. During self refresh mode, the controller 704 operates in the panel self refresh mode and obtains the saved frame from the frame buffer and puts it to the screen. In this example, if the input to the source input interface from the image source is already of a vertical scan format, the frame buffer memory is not used and instead the information is passed through the panel self refresh controller in a pass-through mode to the panel driver interface. However, if the input is in a horizontal scan format, then the memory 306 is used to convert the horizontal scan format information to a vertical scan format information.

Also, integrated circuit design systems (e.g., work stations including, as known in the art, one or more processors, associated memory in communication via one or more buses or other suitable interconnect and other known peripherals) are known that create wafers with integrated circuits based on executable instructions stored on a computer readable medium such as but not limited to CDROM, RAM, other forms of ROM, hard drives, distributed memory, etc. The instructions may be represented by any suitable language such as but not limited to hardware descriptor language (HDL), Verilog or other suitable language. As such, the logic and circuits described herein may also be produced as integrated circuits by such systems using the computer readable medium with instructions stored therein. For example, an integrated circuit with the aforedescribed logic and structure may be created using such integrated circuit fabrication systems. In such a system, the computer readable medium stores instructions executable by one or more integrated circuit design systems that causes the one or more integrated circuit design systems to produce an integrated circuit. The integrated circuit includes logic operative to determine whether a mode of operation of the vertical scan panel is at least one of scan conversion pass-through mode and a horizontal scan conversion mode, a horizontal to vertical scan controller operative to convert display data from a horizontal scan format to a vertical scan format if the determined mode is the horizontal scan conversion mode, and wherein the controller is operative to cause the displaying of display data on the screen in a vertical scan format without applying a scan conversion operation on the display data, if the determined mode is the scan conversion pass-through mode.

Among other advantages, in one example, using PSR timing controllers that already have embedded frame buffer operation may result in little additional overhead costs in supporting an improved vertical scan panel operation and the scan mode can be controlled by the image source device or by the vertical scan panel (timing controller for example) depending upon the situation. The pass-through mode of operation can yield better performance by reducing image latency. In addition, new EDID/DID fields can allow for plug and play operation for communicating capability information between the vertical scan panel and the image source. Other advantages will be recognized by those of ordinary skill in the art.

The above detailed description of the invention and the examples described therein have been presented for the purposes of illustration and description only and not by limitation. It is therefore contemplated that the present invention cover any and all modifications, variations or equivalents that fall within the spirit and scope of the basic underlying principles disclosed above and claimed herein.

What is claimed is:

1. A method for providing an image on a vertical scan panel comprising:
determining whether a mode of operation for a vertical scan panel is at least one of scan conversion pass-through mode and a horizontal scan conversion mode;
if the determined mode is the horizontal scan conversion mode, converting display data from a horizontal scan format to a vertical scan format and displaying the converted display data on the vertical scan panel using a self-refresh frame buffer in the panel to self-refresh pixel data for the panel and using the same self-refresh buffer in the vertical scan panel to convert horizontally scanned pixel data to vertically scanned pixel data for output on the vertical scan panel; and
if the determined mode is the scan conversion pass-through mode, displaying display data on the vertical scan panel in a vertical scan format without applying a scan conversion operation on the display data.

2. The method of claim 1 comprising:
converting display data from a horizontal scan format to a vertical scan format by an image source device to produce converted vertical scan display data;
sending the converted vertical scan display data to the vertical scan panel;
operating in a scan conversion pass-through mode and displaying display data on the vertical scan panel in a vertical scan format in response to the sent converted vertical scan display data.

3. The method of claim 2 comprising:
sending vertical scan panel capability data to an image source device indicating that the vertical scan panel can perform horizontal scan format to vertical scan format conversion; and
in response, sending by the image source, display data in a horizontal scan format to the vertical scan panel for display.

4. The method of claim 1 comprising providing, by the vertical scan panel, a panel self-refresh operation using the self refresh frame buffer in response to a static mode of a screen of the vertical scan panel.

5. A method for providing an image on a vertical scan panel comprising:
using a frame buffer in the vertical scan panel during a self refresh mode; and
also using the frame buffer in the vertical scan panel to convert display data from a horizontal scan format to a vertical scan format when the vertical scan panel is out of a self refresh mode.

6. The method of claim 5 comprising:
sending vertical scan panel capability data to an image source device indicating that the vertical scan panel can perform horizontal scan format to vertical scan format conversion; and
in response, sending, by the image source, display data in a horizontal scan format to the vertical scan panel for display.

7. A vertical scan panel comprising:
a controller operative to determine whether a mode of operation of the vertical scan panel is at least one of scan conversion pass-through mode and a horizontal scan conversion mode;
a horizontal to vertical scan controller operative to convert display data from a horizontal scan format to a vertical scan format if the determined mode is the horizontal scan conversion mode;
a self refresh frame buffer;
a screen operative to display the converted display data; and
wherein the controller is operative to cause the displaying of display data on the screen in a vertical scan format without applying a scan conversion operation on the display data, if the determined mode is the scan conversion pass-through mode and wherein converting display data from a horizontal scan format to a vertical scan format comprises using the self-refresh frame buffer to self-refresh pixel data and using the same self-refresh frame buffer to convert horizontally scanned pixel data to vertically scanned pixel data for output on the screen.

8. The vertical scan panel of claim 7 wherein the controller is operative to send vertical scan panel capability data to an image source device indicating that the vertical scan panel can perform horizontal scan format to vertical scan format conversion.

9. The vertical scan panel of claim 7 wherein the controller comprises a switching circuit operative to select between at least a vertical scan saved frame in a self refresh mode and a converted frame from that was is in the horizontal scan format.

10. An image source device comprising:
a horizontal to vertical scan converter operatively controlled to convert display data from a horizontal scan format to a vertical scan format to produce converted vertical scan display data in response to vertical scan panel mode capability data;
a vertical scan controller operative to control the horizontal to vertical scan converter in response to the vertical scan panel mode capability data; and
a display interface operative to send the converted vertical scan display data to a vertical scan panel.

11. A display system comprising:
a vertical scan panel comprising:
a controller operative to determine whether a mode of operation of the vertical scan panel is at least one of scan conversion pass-through mode and a horizontal scan conversion mode;
a horizontal to vertical scan controller operative to convert display data from a horizontal scan format to a vertical scan format if the determined mode is the horizontal scan conversion mode,
a screen operative to display the converted display data;
wherein the controller is operative to cause the displaying of display data on the screen in a vertical scan format without applying a scan conversion operation on the display data, if the determined mode is the scan conversion pass-through mode; and
an image source device comprising:
a horizontal to vertical scan converter operatively controlled to convert display data from a horizontal scan format to a vertical scan format to produce converted vertical scan display data in response to vertical scan panel mode capability data;
a display interface operative to send the converted vertical scan display data to a vertical scan panel; and
wherein the vertical scan panel comprises a self refresh frame buffer and wherein converting display data from a horizontal scan format to a vertical scan format comprises using the self-refresh frame buffer to self-refresh pixel data and using the same self-refresh frame buffer to convert horizontally scanned pixel data to vertically scanned pixel data for output on the screen.

12. The display system of claim 11 wherein the controller of the vertical scan panel is operative to send vertical scan panel capability data to an image source device indicating that the vertical scan panel can perform horizontal scan format to vertical scan format conversion.

13. The display system of claim 11 wherein the image source device comprises a vertical scan controller operative to control the horizontal to vertical scan converter in response to the vertical scan panel mode capability data.

14. The display system of claim 13 wherein the controller of the vertical scan panel is a timing controller and wherein the self refresh frame buffer is embedded in a same die as the timing controller.

15. The display system of claim 13 wherein the controller of the vertical scan panel comprises a switching circuit operative to select between at least a vertical scan saved frame in a self refresh mode and a converted frame from that was is in the horizontal scan format.

16. The display system of claim 13 wherein the image source device comprises a graphics processor operative to produce a frame of horizontally scan display data or convert a frame of horizontally scan display data into a vertical scan format for display on the vertical scan panel.
